(19) United States
(12) Patent Application Publication
(10) Pub. No.: US 2006/0276554 A1
(43) Pub. Date: Dec. 7, 2006

(54) Defoaming agents devoid of emulsifiers, method for producing said agents and use thereof

(75) Inventors: Rainer Dyllick-Brenzinger, Speyer (DE); Markus Schmid, Deidesheim (DE); Jorg Wehrle, Heppenheim (DE); Klaus Lorenz, Worms (DE); Stefan Bruhns, Mannheim (DE); Michael Senge, Weisenheim (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/570,154

(22) PCT Filed: Aug. 27, 2004
(86) PCT No.: PCT/EP04/09569

§ 371 Date: Mar. 1, 2006

(30) Foreign Application Priority Data
Sep. 1, 2003 (DE) 103405402

(51) Int. Cl. B01D 17/05

(52) U.S. Cl. 516/137

(57) ABSTRACT

Emulsifier-free antifoams are obtainable by mixing a) from 80 to 99% by weight of at least one finely divided, virtually water-insoluble, inert solid with b) from 1 to 20% by weight of at least one hydrophobic, organic compound which has an antifoam action and is solid at room temperature in the absence of a solvent in a shear gradient such that the particle size of the compounds (b) which have an antifoam action is reduced to a mean particle size of from 0.5 to 15 μm, emulsifier-free oil-in-water dispersions of mixtures of (a) and (b) are prepared by mixing the component (a) in an amount of from 80 to 99% by weight with the compounds of component (b) in an amount of from 1 to 20% by weight in the absence of emulsifiers in an extruder or kneader in a manner such that the mean particle size of the component (b) in the mixture is brought to 0.5 to 15 μm, at up to 100° C., and emulsifying the mixture in water, and the oil-in-water dispersions thus obtainable are used as antifoams and/or deaerators for aqueous, disperse or nondisperse liquids, in particular as antifoams and/or deaerators in the paper industry, in the food industry and in wastewater treatment plants.

The present invention relates to a process for the preparation of emulsifier-free antifoams and their use in the form of oil-in-water dispersions as antifoams and/or deaerators for aqueous, disperse or nondisperse liquids, in particular in the paper industry.

DE-C-21 57 033 discloses a process for defoaming aqueous systems by means of emulsions or dispersions which contain C₁- to C₂₂-alkanols and/or C₁₂- to C₂₂-fatty acid esters of dihydric or trihydric alcohols, and liquid paraffin and/or C₁₂- to C₂₂-fatty acids as antifoams and surfactants added in the manner known per se as emulsifiers. The emulsified water-insoluble substances have a mean particle size of from 4 to 9 μm. The known antifoam emulsions have the disadvantage that they cream during storage and in some cases even thicken to such an extent that such mixtures can then no longer be pumped.

U.S. Pat. No. 3,408,306 discloses a process for defoaming aqueous systems, in which an antifoam mixture which consists of from 80 to 97% by weight of a water-soluble hydrophobic organic liquid (e.g. mineral oil, long-chain alcohols, esters or amines) and of from 3 to 20% by weight of hydrophobic finely divided solids (e.g. silica, bentonite, talc or titanium dioxide) is used. The antifoam mixture can, if required, contain up to 5% by weight of a surfactant. A substantial feature of these antifoam mixtures is that the finely divided solids are rendered hydrophobic with substances (e.g. dimethylpolysiloxane oils) which are usually used as antifoams. The preparation of finely divided solids which have been rendered hydrophobic is, however, technically complicated.

EP 230 977 discloses antifoams based on oil-in-water emulsions, in which the oil phase contains
(a) a C₁₂- to C₂₆-alcohol, distillation residues which are obtainable in the preparation of alcohols of >10 carbon atoms by oxo synthesis or by the Ziegler process, and/or alkoxylated alcohols
(b) a fatty acid ester of C₁₂- to C₂₂-carboxylic acids with a monohydric to trihydric C₁- to C₁₈-alcohol and, if required,
c) a hydrocarbon having a boiling point above 200° C. or fatty acids of 12 to 22 carbon atoms, accounts for from 5 to 50% by weight of the emulsion and has a mean particle size of <25 μm. The nonaqueous components of the oil-in-water emulsion contain from 0.1 to 50% by weight of finely divided, virtually water-insoluble, inert solids which have not been rendered hydrophobic on the surface and have a particle diameter of <20 μm. These antifoams can be prepared, for example, by first melting organic compounds which are solid at room temperature and form the oil phase of the emulsions and then introducing one or more inert solids, such as kaolin, talc, microcrystalline cellulose or crosslinked starch, into the melt and thus ensuring thorough mixing of the components. The components can also be mixed at from 50 to 100° C. For the preparation of the oil-in-water emulsions, the mixture is then emulsified in water in the presence of at least one emulsifier. The mean particle size of the droplets of the oil phase which are emulsified in water is preferably from 0.5 to 15 μm. However, these antifoams have the disadvantage that the emulsifier necessarily contained therein adversely affect the efficiency of the antifoams.

It is an object of the present invention to provide an emulsifier-free antifoam and/or deaerator.

We have found that this object is achieved, according to the invention, by emulsifier-free antifoams which are obtainable by mixing
a) from 80 to 99% by weight of at least one finely divided, virtually water-insoluble, inert solid with
b) from 1 to 20% by weight of at least one hydrophobic, organic compound which has an antifoam action and is solid at room temperature
   in the absence of a solvent in a shear gradient such that the particle size of the compounds (b) having an antifoam action is reduced to a mean particle size of from 0.5 to 15 μm.

The mixing of the components (a) and (b) is preferably effected in an extruder or kneader but can also be carried out in a fluidized bed. During the mixing in the fluidized bed, for example, at least one pulverulent component (a) is initially taken in a fluidized bed reactor and at least one organic compound (b) which is solid at room temperature (i.e. 20° C.) is metered in liquid form into the fluidized bed. The metering in liquid form means that the compounds (b) are melted or they are introduced in the form of a solution in a readily volatile solvent into the fluidized bed under conditions such that the solvent evaporates. The temperature in the fluidized bed may be, for example, from 0 to 130° C. The upper limit for said temperature range may be higher or lower and depends substantially on the decomposition temperature of the compounds of component (a). If the compounds of component (a) are thermally labile, the upper limit for the temperature in the fluidized bed is preferably at least 10° C. below the decomposition temperature of these compounds.

For the novel antifoams, it is possible to use all inert solids which do not react with the components of the antifoam mixture and which are virtually insoluble in water. Preferably used inert solids are kaolin, chalk, calcium sulfate, barium sulfate, talc, flour, such as rye flour, wheat flour, corn flour or potato starch, microcrystalline cellulose and/or crosslinked starch. There are no restrictions regarding the usability of solids, apart from the fact that the solids should be inert and preferably should not have been rendered hydrophobic. Both inorganic and organic solids untreated on the surface may be used; for example, in addition to the abovementioned solids, the following are suitable: sheet silicates, such as bentonite, montmorillonite, nontronite, hectorite, saponite, volkonskoite, sauconite, beidellite, allevardite, illite, halloysite, attapulgite and sepiolite, and titanium dioxide, alumina, silica, satin white, synthetic aluminum silicates, crosslinked urea/formaldehyde and melamine/formaldehyde or melamine/iosbutyraldehyde condensates and homo- and copolymers of styrene, which are disclosed, for example, in GB-A-1 229 503. Urea/formaldehyde condensates, which are also referred to as methyleneureas, are obtained by condensation of precondensates of urea and formaldehyde in the molar ratio of 1:1 or less than 1 in the presence of strongly acidic catalysts at a pH below 2 (cf. DE-B-2 110 309) or by the process of U.S. Pat. No. 3,931,063. The condensates obtainable according to DE-A-25 47 966 are also suitable. Mixtures of the inorganic inert solids, of the organic inert solids and also mixtures of inorganic and organic inert solids may be used. The organic and inorganic finely divided solids are preferably used in a form which has not been rendered hydrophobic. The mean particle size of the finely divided inert solids is, for example, from 1 to 100 μm and that of fibrous particles, such as cellulose fibers, is up to 1 mm. The mean particle size of the inert solids is preferably from 10 to 200 μm, in general from 10 to 100 μm.

Preferably used finely divided, inert solids (a) are, for example, kaolin, sheet silicates, chalk, calcium sulfate, barium sulfate, talc, titanium dioxide, alumina, silica, satin white, cellulose fibers, urea/formaldehyde pigments, melamine/formaldehyde pigments, flours, starch and/or crosslinked starch. Crosslinked starch and groundwood are particularly preferably used as component (a). When the novel antifoams/deaerators are used in the paper industry, the various flour and starch types which are suitable as component (a) also have the advantage that they increase the strength of the paper products.

It is possible to use, as hydrophobic compounds (b) which have an antifoam action, all compounds known for this purpose, e.g. C₁₂- to C₂₆-alcohols, distillation residues which are obtainable in the preparation of alcohols of >10 carbon atoms by oxo synthesis or by the Ziegler process, alkoxylated alcohols of 12 to 26 carbon atoms, 3-thiaalkan-1-ols, 3-thiaoxaalkan-1-ols, 3-thiadioxaalkan-1-ols and esters of said 3-thiaalkanols, 3-thiaoxaalkanols and 3-thiadioxaalkanols. Such antifoams/deaerators are described, for example, in DE-C-21 57 033 mentioned in connection with the prior art and in the following literature: EP-A-0 149 812, DE-A-30 01 387, EP-A-0 531 713, EP-A-0 662 172 and EP-A-0 732 134 and in EP 1 114 220, page 3, line 33 to page 10, line 35. Antifoams/deaerators based on 3-thiaalkan-1-ols, 3-thiaoxaalkan-1-ols, 3-thiadioxaalkan-1-ols and esters of said 3-thiaalkanols, 3-thiaoxaalkanols and 3-thiadioxaalkanols are disclosed in EP 1 152 811, page 3, line 31 to page 13, line 20.

Of particular interest are antifoams/deaerators which contain
(i) a C₁₂- to C₂₆-alcohol, distillation residues which are obtainable in the preparation of alcohols of >10 carbon atoms by oxo synthesis or by the Ziegler process, alkoxylated alcohols of 12 to 26 carbon atoms, 3-thiaalkan-1-ols, 3-thiaoxaalkanols, 3-thiadioxaalkanols in combination with
(ii) at least one compound from the group consisting of the glyceryl esters of fatty acids having at least 10 carbon atoms in the molecule, C₁₂- to C₃₀-alcohols, alkoxylated alcohols, esters of sugar alcohols having at least 4 OH groups or at least 2 OH groups and at least one intramolecular ether bond and a fatty acid having at least 20 carbon atoms in the molecule, fatty acid esters of C₁₂- to C₂₂-carboxylic acids with monohydric to trihydric alcohols, ketones having melting points above 45° C., the polyglyceryl esters which are obtainable by at least 20% esterification of polyglycerols which have at least 2 glycerol units with at least one C₁₂- to C₃₆-fatty acid, reaction products of mono- and diglycerides with dicarboxylic acids, reaction products of glycerol with dicarboxylic acids, which reaction products have been esterified with at least one C₁₂- to C₃₆-fatty acid, polyethylene waxes, natural waxes, hydrocarbons having boiling points above 200° C. and mixtures of said compounds.

Preferred antifoams preferably contain
(a) a crosslinked starch and/or cellulose fibers as the finely divided, inert solids and
(b) at least one C₁₂- to C₃₆-alcohol and a polyglyceryl ester of a carboxylic acid of 18 to 36 carbon atoms as the hydrophobic organic compound having an antifoam action. The component (b) of these antifoams may contain the hydrophobic organic compounds which are known from the literature and have an antifoam action, such as organic esters and/or amides, in addition to C₁₂- to C₃₀-alcohols and a polyglyceryl ester of a carboxylic acid of 18 to 36 carbon atoms.

The emulsifier-free, pulverulent antifoams contain the component (a) in an amount of from 80 to 99, preferably from 88 to 95, % by weight and the component (b) in an amount of from 1 to 20, preferably from 5 to 12, % by weight. The mean particle size of the component (b) in the novel antifoams is, for example, from 0.5 to 15 μm, preferably from 0.5 to 5 μm.

The present invention also relates to a process for the preparation of emulsifier-free oil-in-water dispersions of mixtures of (a) at least one finely divided, virtually water-insoluble, inert solid and (b) at least one hydrophobic, organic compound which has an antifoam action and is solid at room temperature by mixing the components (a) and (b) at up to 100° C. and emulsifying/dispersing the mixture in water, the mixture containing the compounds of component (a) in an amount of from 80 to 99% by weight and the compounds of component (b) in an amount of from 1 to 20% by weight, and the components (a) and (b) being mixed in the absence of emulsifiers in an extruder or kneader in a manner such that the mean particle size of the component (b) in the mixture is brought to 0.5 to 15 μm. The mixing of the two components is effected in the absence of a solvent, preferably in the absence of water. The components (a) and (b) can, however, contain adhering water, e.g. as water of crystallization, for example up to 30% by weight. Preferably, however, they contain not more than 15% by weight of water. The components (a) and (b) are subjected to a sharp shear gradient, for example in an extruder or kneader. They are mixed therein at least until the mean particle size of the component (b) in the mixture is from 0.5 to 15 μm, preferably from 0.5 to 5 μm. The particles of the compounds (b) which have an antifoam action are smaller than the particulate, inert solids (a). Below the melting point or the softening point of the compounds (b) which have an antifoam action, the mixture of the components (a) and (b) may be regarded as a solid-in-solid dispersion.

The extruder must, for example, form a plurality of process engineering functions:
preparation of a solid/wax mixture, the wax phase (component (b)) being finely emulsified by a high degree of shearing
introduction of the fat phase melt, which is melted in a separate mixing vessel and pumped into the extruder
homogenization of the fat phase melt with the undigested starch (what is important here is that no water is added, so that digestion of the starch is avoided. However, the starch may contain, for example, up to 15% by weight of water.)
at least partial cooling of the molten mixture and, if required,

shaping of the cooling melt to give pellets, scales, tubes, powders or short spaghettis.

The extruder used may be divided into a plurality of process zones. The individual process zones need not be identical to the individual extruder sections. In general, a process zone extends over a plurality of extruder sections.

The following general scheme is by way of example for the novel process:

Zone 1: Feed of the components, may extend over a plurality of sections and is provided with feed orifices for solid, liquid feed and, if required, vapor feed. One or more feed orifices may be provided per extruder section.

The feed orifices may be located at the top, at the side or at the bottom of each of the extruder sections considered, any conceivable combination being possible, for example large feed orifices at the top for powder metering and at the bottom or side for liquid metering and, if required, feed orifices at the top, side or bottom for vapor.

In another preferred embodiment, the solid components are fed to the extruder via a metering and feed means at the side, and the liquid components and, if required, the vapor are introduced from the side, from above or from below.

In a preferred embodiment, the solid, generally pulverulent components (starch or other solids) are introduced via a side feed means into the same section as the liquid components.

In the region of zone 1, the screw elements are, for example, in the form of pure conveying elements and may differ in pitch, number of flights and profile according to the task. In a preferred embodiment, double-flight screw elements of different pitch, having an earth mixer profile, are used. However, other profiles, for example a thrust edge profile, etc., are also conceivable.

In the subsequent zone 2, which as a rule likewise extends over a plurality of extruder sections, the emulsification of the wax phase is effected by thorough mixing and kneading of the components. As a rule, closed barrels are used here. In this region, the extruder screw is equipped with conveying and mixing elements which, depending on starting materials used and the ratio thereof, can be chosen to be different and can be differently arranged. Suitable conveying elements are firstly all elements described above under zone 1. Suitable mixing and kneading elements are neutral or conveying kneading blocks of different width and number of kneading disks, backward-conveying kneading blocks also being suitable. Other suitable mixing elements are toothed disks, toothed mixing elements and melt mixing elements of a very wide range of embodiments, as are available from various manufacturers. Hold-up disks and backward-conveying screw elements can also provide the desired mixing effect. In a particular novel embodiment, the extruder is equipped, in a part of zone 2, alternately with conveying and individual mixing and kneading elements. In another preferred embodiment, it is equipped alternately with conveying elements and groups of kneading elements.

In a very particularly preferred embodiment, the mixing of the components (a) and (b) is supported by the additional introduction of energy, for example with the aid of ultrasound.

Zone 2 is followed by the discharge zone 3. This consists of one or more closed barrels having conveying screw elements. The discharge zone can be closed with a die plate, a slot die or other elements, or the extruder is connected directly to a shaping process part in which the emerging melt is brought into a further processible form (powder, granules, scales). For the preparation of pellets or scales, the machines known from the prior art, for example a cooling belt, chill roll or the like, are used. For powders, as a rule milling units are connected.

In a particularly preferred embodiment, the extruder is cooled in the discharge region so that the prepared product is discharged as agglomerated powder. It is readily dispersible in water. The 0.5 to 15 μm wax particles of component (b) are liberated under gentle shearing and are then able to display their efficiency as an antifoam and/or deaerator. The solid carrier (component (a)) is itself substantially ineffective as a deaerator but does not interfere with the application. As stated above, an increase in the dry strength of the paper products is obtained in papermaking with the use of antifoams/deaerators which contain flour and/or starch types as component (a).

In order to prepare oil-in-water dispersions which can be used as antifoams and/or deaerators from the novel mixtures, the mixtures which comprise the components (a) and (b) and are solid at room temperature (20° C.) are advantageously dispersed in water in comminuted form, for example as a powder, granules or pellets. The dispersing can be effected, for example, in a container equipped with a stirrer by simple stirring or by the action of shear forces, for example with the aid of an Ultra-Turrax apparatus. The dispersing or suspending process can, if required, be effected with the aid of dispersants, which may in any case be present in small amounts in aqueous media in industrial chemistry. The presence of such dispersants is, however, not essential for displaying the antifoam/deaerating effect. The resulting oil-in-water dispersions have a solids content [sum of the components (a) and (b)] of, for example, from 0.1 to 20, preferably from 0.1 to 5, % by weight. They are preferably used directly after their preparation. The solid particles (b) in the novel mixture of the components (a) and (b), which particles are effective as antifoams and/or deaerators, undergo controlled release during the defoaming or deaeration process.

The oil-in-water dispersions thus obtainable are used as antifoams and/or deaerators for aqueous, disperse or nondisperse liquids. They are preferably used as antifoams and/or deaerators in the paper industry, in the food industry and in wastewater treatment plants.

### EXAMPLES

General Conditions:

The kneading experiments were all carried out in a measuring kneader from Janke & Kunkel. The oil bath temperature was 75° C., and the temperature measurement in the kneader was usually 65° C. and was measured in the kneading blade by means of a thermocouple. The kneader speed was usually 50 rpm. In the novel mixtures with the compounds of component (a), the mean particle size of the hydrophobic, organic compounds (b) which have an antifoam action and are solid at room temperature was in each case from 1 to 10 μm.

The extruder experiments were carried out in a ZSK 30/2 from Werner & Pfleiderer, combination 179 having a metering screw for metering starch.

The tests for the deaerating effect were carried out in an apparatus specially produced for this purpose. 10 l of a 0.4% strength groundwood suspension (at 50° C.) were circulated by pumping at a flow rate of about 600 l/h through a Coriolis force transducer from ABB, with the name of Trio-Mass flow meter, which continuously records the density of the stock suspension. After a steady state had been established, an air content of about 3.5% (corresponding to a density of 0.965 kg/l) was present. After the metering of 1 ml of a deaerator suspension having a solids content of about 1%, the foam formed rapidly collapsed. The density immediately increased to 0.982 kg/l. Depending on the quality of the antifoam/deaerator, the high density of the defoamed/deaerated medium was maintained for several minutes. The difference between the density in the steady state (minimum density) and the highest achievable density is determined as a measure of the maximum effect (delta in the table). The solid antifoams were each dispersed about 0.5% strength in water using an ultrasonic finger from Hilscher at RT. The concentration was chosen so that the fat phase concentration was the same as in the comparative example according to the prior art.

In the examples which follow, parts and percentages are by weight.

### Example 1

Preparation of the Solid Antifoam

In a kneader from Janke & Kunkel, 10.5 g of a mixture of 6 g of polyglyceryl behenate, 27 g of a natural glyceryl ester and 67 g of a long-chain, linear C₁₈-fatty alcohol (available from Condea under the name Nafol®) were mixed for ½ hour with 89.5 g of a crosslinked, natural wheat starch (available under the name Amyzet® 200 from Amylum, Belgium) having a mean particle size of from 20 to 40 μm. During this procedure, the temperature in the interior of the kneader increased to 63° C. Kneading was then carried out at this temperature at a speed of 50 rpm for ½ hour. The mixture thus obtainable was then discharged. 98 g of a white powder which, after dispersing in water, had good deaerating/antifoam properties were obtained in this manner. The mean particle size of the hydrophobic compounds was 4 μm. The results of the test are listed in the table.

### Example 2

A crosslinked starch (Amyzet 200) and, 5 cm further on, the wax mixture comprising polyglyceryl behenate, natural glyceryl ester and C₁₈-alcohol, stated in example 1, were metered continuously into a twin-screw extruder having a length of 0.98 m and an internal diameter of the two sections of 3 cm in a ratio such that the resulting mixture contained 10% of the wax mixture. The temperature in the extruder was kept at 65° C. A white powder which, after dispersing in water, had very good antifoam and deaerating properties was obtained in this manner, cf. table. The dispersed fat phase had a mean particle size of 6 μm in the mixture.

### Example 3

Example 1 was repeated, except that in this case Amyzet 262 (from Amylum) was used instead of Amyzet 200. A white powder in which the dispersed fat phase had a mean particle size of 5 μm was obtained. As is evident from the table, the powder had good deaerating properties after dispersing in water.

### Example 4

Example 1 was repeated, except that a mixture of long-chain, linear C₁₄- to C₂₂-alcohols was used instead of the wax mixture. A white powder in which the hydrophobic phase which is solid at room temperature (20° C.) had a mean particle size of 4 μm was obtained. As is evident from the table, the pulverulent mixture had good deaerating properties after dispersing in water.

### Comparative Example (According to Example 8 of DE-A 3601929)

14.46 g of a glyceryl triester of C₁₆- to C₁₈-fatty acids, 10.34 g of a long-chain, linear C₁₈-fatty alcohol (available from Condea under the name Nafol®)) and 6.2 g of a commercial mineral oil were melted at 80° C. 30 g of a crosslinked, natural wheat starch (Amyzet® 200) having a mean particle size of from 20 to 40 μm were then added with stirring. The mixture was then cooled to 60° C., a solution of 11.765 g of the sulfuric monoester of an adduct of 25 mol of ethylene oxide with one mole of isooctylphenol in 127.25 g of demineralized water was added and emulsification was effected in the course of 2 minutes using an Ultraturrax®. A creamy dispersion having a particle size distribution of the fat phase of from 0.5 to 5 μm was obtained. The particle size of the starch particles had not changed. The dispersion was then tested for its deaerating effect in the ABB Measuring unit described above. The results are shown in the table.

TABLE

| | | | | Minimum/Maximum | Persistence |
|---|---|---|---|---|---|
| | Component | | Technology of | density at | after |
| | (a) | Component | preparation | 50° C. | 5 minutes |
| | (Starch) | (b) | (mixing unit) | (Delta)* | at 50° C.** |
| Example 1 | Amyzet ® | Wax | Kneader | 0.969/0.979 | 5 |
| | 200 | mixture | | (10) | |
| Example 2 | Amyzet | Wax | Extruder | 0.966/0.980 | 3 |
| | 200 | mixture | | (14) | |
| Example 3 | Amyzet | Wax | Kneader | 0.967/0.981 | 6 |
| | 262 | mixture | | (14) | |
| Example 4 | Amyzet | C₁₄-/C₂₂- | Kneader | 0.965/0.979 | 5 |
| | 200 | alcohols | | (14) | |
| Comparative | Amyzet | Nafol ®, | Emulsification of | 0.9700/0.9775 | 3 |
| example | 200 | glyceryl | the melt in water | (7.5) | |
| | | ester, | in the presence | | |
| | | mineral oil | of emulsifier with | | |
| | | | Ultraturrax ® | | |

*Delta is the difference between the maximum and minimum density multiplied by 1 000. The values stated in brackets are a measure of the efficiency of the antifoams/deaerators. The higher the value, the better is the deaerating effect of the products.
**The persistence is a measure of the long-term action of the antifoam/deaerator. The lower the value, the longer it is effective. The persistence is calculated from the difference between the maximum density and the density after 5 minutes multiplied by 1 000.

1. An emulsifier-free antifoam obtained by mixing
a) from 80 to 99% by weight of at least one finely divided, virtually water-insoluble, inert solid with
b) from 1 to 20% by weight of at least one hydrophobic, organic compound which has an antifoam action and is solid at room temperature
in the absence of a solvent in a shear gradient such that the particle size of the compounds (b) having an antifoam action is reduced to a mean particle size of from 0.5 to 15 μm.

2. The emulsifier-free antifoam as claimed in claim 1, wherein the mixing of the components (a) and (b) is effected in an extruder or kneader.

3. The emulsifier-free antifoam as claimed in claim 1, wherein the mixing of the components (a) and (b) is carried out in a fluidized bed.

4. The emulsifier-free antifoam as claimed in claim 1, wherein kaolin, sheet silicates, chalk, calcium sulfate, barium sulfate, talc, titanium dioxide, alumina, silica, satin white, cellulose, groundwood, urea/formaldehyde pigments, melamine/formaldehyde pigments, starch and/or crosslinked starch are used as the finely divided, inert solids (a).

5. The emulsifier-free antifoam as claimed in claim 1, wherein a C₁₂- to C₂₆-alcohol, distillation residue obtained in the preparation of alcohols of >10 carbon atoms by oxo synthesis or by the Ziegler process, alkoxylated alcohols of 12 to 26 carbon atoms, 3-thiaalkan-1-ols, 3-thiaoxaalkan-1-ols, 3-thiadioxaalkan-1-ols and esters of said 3-thiaalkanols, 3-thiaoxaalkanols and thiadioxadialkanols are used as the hydrophobic compounds (b) having an antifoam action.

6. The emulsifier-free antifoam as claimed in claim 1, wherein
(i) a C₁₂- to C₂₆-alcohol, distillation residue obtained in the preparation of alcohols of >10 carbon atoms by oxo synthesis or by the Ziegler process, alkoxylated alcohols of 12 to 26 carbon atoms, 3-thiaalkan-1-ols, 3-thiaoxaalkanols and thiadioxaalkanols in combination with
(ii) at least one compound selected from the group consisting of the glyceryl esters of fatty acids having at least 10 carbon atoms in the molecule, C₁₂- to C₃₀-alcohols, alkoxylated alcohols, esters of sugar alcohols having at least 4 OH groups or at least 2 OH groups and at least one intramolecular ether bond and a fatty acid having at least 20 carbon atoms in the molecule, fatty acid esters of C₁₂- to C₂₂-carboxylic acids with monohydric to trihydric alcohols, ketones having melting points above 45° C., the polyglyceryl esters which are obtainable by at least 20% esterification of polyglycerols which have at least 2 glycerol units with at least one C₁₂- to C₃₆-fatty acid, reaction products of mono- and diglycerides with dicarboxylic acids, reaction products of glycerol with dicarboxylic acids, which reaction products have been esterified with at least one C₁₂- to C₃₆-fatty acid, polyethylene waxes, natural waxes, hydrocarbons having boiling points above 200° C. and mixtures of said compounds
are used as component (b).

7. The emulsifier-free antifoam as claimed in claim 1, wherein
(a) a crosslinked starch and/or cellulose fibers are used as the finely divided, inert solids and
(b) at least one C₁₂- to C₃₀-alcohol and a polyglyceryl ester of a carboxylic acid of 18 to 36 carbon atoms are used as the hydrophobic organic compound having an antifoam action.

8. The emulsifier-free antifoam as claimed in claim 1, wherein
(a) a crosslinked starch and/or cellulose fibers are used as the finely divided, inert solids and
(b) at least one C₁₂- to C₃₀-alcohol, a polyglyceryl ester of a carboxylic acid of 18 to 36 carbon atoms and further organic esters and/or amides having an antifoam action are used as the hydrophobic organic compound having an antifoam action.

9. The emulsifier-free antifoam as claimed in claim 1, wherein the component (a) is contained in an amount of from 88 to 95% by weight and the component (b) in an amount of from 5 to 12% by weight in the mixture, and wherein the mean particle size of the component (b) is from 0.5 to 5 μm.

10. A process for the preparation of emulsifier-free oil-in-water dispersions of mixtures of (a) at least one finely divided, virtually water-insoluble, inert solid and (b) at least one hydrophobic, organic compound which has an antifoam action and is solid at room temperature comprising mixing the components (a) and (b) at up to 100° C. and emulsifying/dispersing the mixture in water, wherein the mixture contains the compounds of component (a) in an amount of from 80 to 99% by weight and the compounds of component (b) in an amount of from 1 to 20% by weight, and wherein the components (a) and (b) are mixed in the absence of emulsifiers in an extruder or kneader in a manner such that the mean particle size of the component (b) in the mixture is brought to 0.5 to 15 μm.

11. The process as claimed in claim 10, wherein the components (a) and (b) are mixed in a kneader at least until the mean particle size of the component (b) in the mixture is from 0.5 to 5 μm.

12. An emulsifier and/or deaerator for aqueous, disperse or nondisperse liquids comprising the oil-in-water dispersion obtained by the process as claimed in claim 10.

13. An antifoam and/or deaerator for use in the paper industry, in the food industry and in wastewater treatment plants comprising the oil-in-water dispersion obtained by the process as claimed in claim 10.
